(19) United States
(12) Patent Application Publication
(10) Pub. No.: US 2012/0235965 A1
(43) Pub. Date: Sep. 20, 2012

(54) LIQUID CRYSTAL DISPLAY DEVICE FREE OF UPPER SUBSTRATE ELECTRODE AND DRIVING METHOD THEREOF

(75) Inventor: Cheng-Chiu PAI, Hsin-Chu (TW)

(73) Assignee: AU OPTRONICS CORP., HSINCHU (TW)

(21) Appl. No.: 13/282,655

(22) Filed: Oct. 27, 2011

(30) Foreign Application Priority Data
Mar. 17, 2011 (TW) 100109210

(51) Int. Cl. G09G 3/36; G06F 3/038

(52) U.S. Cl. 345/206; 345/87

(57) ABSTRACT

In a liquid crystal display device free of upper substrate, a plurality of independent common lines are provided, and a specified one of the plurality of common lines is electrically coupled to a specified group of pixels. A voltage level of the specified common line is changed from a first level to a second level before data are written into the specified group of pixels; and the voltage level of the specified common line is kept at the second level after the data are written into the specified group of pixels.

### TECHNICAL FIELD

The disclosure relates to a liquid crystal display device and display control for the same, and more particularly to configuration and driving method of a liquid crystal display device free of a conventional upper substrate electrode.

### BACKGROUND

Nowadays, liquid crystal displays (LCDs) are widely used due to advantageous features of, for example, high displaying quality, compact size and diverse applications. A LCD has replaced for a traditional CRT display and become main stream among display devices.

A conventional LCD device, if operating under an in-plane switching mode (IPS mode) or a fringe field switching mode (FFS mode), needs to perform dot inversion driving with a direct current common electrode. Consequently, polarities of gray voltages of pixels alternately change with data input into successive pixel rows via respective data lines. A gray voltage is defined as a voltage difference between a pixel level and a common level. The polarities of gray voltages of two adjacent pixel rows are made different, e.g. change from positive to negative or from negative to positive. As a result, high power consumption of an display driver IC is caused.

### SUMMARY

Therefore, the disclosure provides a method of driving a liquid crystal display device free of upper substrate electrode with low power consumption.

The disclosure further provides a liquid crystal display device free of upper substrate electrode, which involves low power driving.

According to an embodiment of the disclosure, a method for driving a liquid crystal display device free of upper substrate comprises providing a plurality of independent common lines; electrically coupling a specified one of the plurality of common lines to a specified group of pixels; changing a voltage level of the specified common line from a first level to a second level before data are written into the specified group of pixels; and keeping the voltage level of the specified common line at the second level after the data are written into the specified group of pixels.

In an embodiment, the second level is a low level if a polarity of the data to be written into the specified group of pixels is positive, and the second level is a high level if a polarity of the data to be written into the specified group of pixels is negative.

According to an embodiment of the disclosure, a liquid crystal display device free of upper substrate comprises a plurality of pixels; a plurality of data lines for providing data to the pixels therethrough, a specified one of the plurality of data lines being electrically coupled to a specified group of pixels selected from the plurality of pixels, wherein two adjacent pixels in the specified group are disposed oppositely relative to the specified data line; a plurality of gate lines for controlling timing of transferring data from the plurality of data lines to corresponding ones of the plurality of pixels; a plurality of common lines, electrically coupled to corresponding groups of pixels selected from the plurality of pixels, respectively; and a common voltage supply unit, electrically coupled to the plurality of common lines for independently providing a voltage level to each of the plurality of common lines, wherein the voltage level is changed from a first level to a second level before data are written into the group of pixels electrically coupled to the corresponding common line, and kept at the second level after data are written into the group of pixels electrically coupled to the corresponding common line.

In an embodiment, a specified one of the plurality of common lines is electrically coupled to another specified group of pixels selected from the plurality of pixels, wherein two adjacent pixels in the another specified group of pixels are electrically coupled to adjacent two of the plurality of gate lines, respectively.

In an embodiment, the plurality of pixels forming a pixel array, the plurality of data lines are distributed in columns within the pixel array, and the plurality of gate lines are distributed in rows within the pixel array; and wherein the specified common line is distributed substantially in rows while in a zigzag manner so that the another specified group of pixels include a first row of pixels coupled to one of the two adjacent gate lines and a second row of pixels coupled to the other of the two adjacent gate lines.

In an embodiment, the second level is a low level if a polarity of the data to be written into the specified group of pixels is positive, and the second level is a high level if a polarity of the data to be written into the specified group of pixels is negative.

### BRIEF DESCRIPTION OF THE DRAWINGS

The above objects and advantages of the disclosure will become more readily apparent to those ordinarily skilled in the art after reviewing the following detailed description and accompanying drawings, in which:

FIG. 1 is a schematic diagram illustrating a matrix of pixel units of an LCD device free of upper substrate;

FIG. 2 is a signal waveform diagram illustrating level changes of signals transmitted through the gate lines and common lines of the LCD device shown in FIG. 1 in two consecutive frames; and

FIG. 3 is a signal waveform diagram illustrating level changes of signals transmitted through a specified common line and a corresponding gate line as well as voltage changes of the pixel electrode of a pixel coupled to the common line.

### DETAILED DESCRIPTION OF PREFERRED EMBODIMENTS

The disclosure will now be described more specifically with reference to the following embodiments. It is to be noted that the following descriptions of preferred embodiments of the disclosure are presented herein for purpose of illustration and description only. It is not intended to be exhaustive or to be limited to the precise form disclosed.

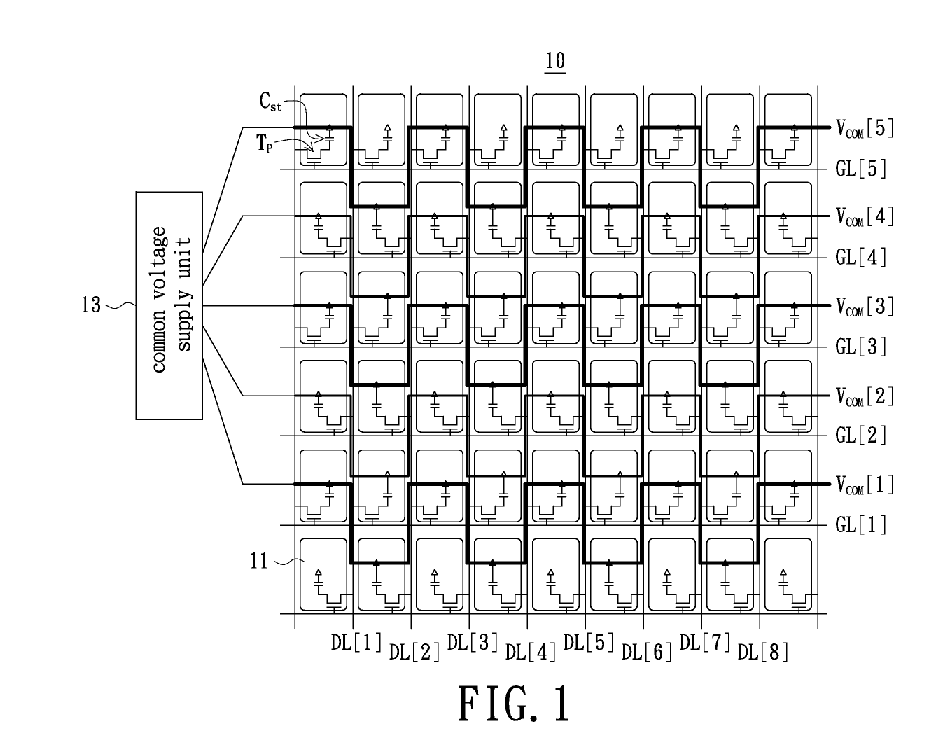

Please refer to FIG. 1, in which a pixel array of an LCD device free of upper substrate is illustrated. According to an embodiment of the disclosure, the LCD device may operate in an IPS mode, an FFS mode or any other suitable mode. Furthermore, the LCD device can be any suitable type of LCD device having common lines and pixel electrodes disposed in a manner other than at opposite sides of liquid crystal molecules.

As shown in FIG. 1, the LCD 10 includes a plurality of pixels 11, a plurality of data lines (DL[1], DL[2], . . . DL[8]), a plurality of gate lines (GL[1], GL[2], . . . GL[5]), a plurality of common lines (Vcom[1], Vcom[2], . . . Vcom[5]), and a common voltage supply unit 13.

The pixels 11 are formed and arranged in columns and rows so as to form a pixel array. Each pixel 11 includes a pixel transistor Tp and a storage capacitor Cst electrically coupled in between a pixel electrode and a common line. The data lines (DL[1], DL[2], . . . DL[8]) are used for providing displayed data to the pixels 11 coupled thereto. The pixels 11 electrically coupled to one of the data lines (DL[1], DL[2], . . . DL[8]) are disposed at different sides of the data line in a zigzag manner.

In more detail, two pixels 11 are electrically coupled to and disposed at opposite sides of one of the data lines (DL[1], DL[2], . . . DL[8]) so that the data line maintains its polarity during the displaying of a frame. Besides, column inversion driving may be used for implementing dot inversion driving so as to decrease power consumption and provide better display qualities. Gate lines (GL[1], GL[2], . . . GL[5]) are used for controlling the timing of transferring data from the data lines (DL[1], DL[2], . . . DL[8]) to corresponding pixels 11.

The operations of the plurality of the common lines (Vcom[1], Vcom[2], . . . Vcom[5]) are independent. Each of the common lines (Vcom[1], Vcom[2], . . . Vcom[5]) is electrically coupled to a plurality of storage capacitors Cst contained in different pixels 11. The distribution of the common lines (Vcom[1], Vcom[2], . . . Vcom[5]) is basically in a direction parallel to that of the gate lines (GL[1], GL[2], . . . GL[5]). Furthermore, each of the common lines (Vcom[1], Vcom[2], . . . Vcom[5]) configured in a constantly zigzag manner is electrically coupled to adjacent gate lines. For instance, the pixels 11 coupled to the common line Vcom[5] include a first group of the pixels 11 electrically coupled to the gate line GL[5] and a second group to the gate line GL[4].

To be more precisely, take the two adjacent rows of pixels at two sides of the gate line GL[5] for instance, the pixels in these two rows are coupled to the common line Vcom[5] in a zig-zag manner. That is, odd-numbered pixels in the upper row and even-numbered pixels in the lower row are both coupled to the same common line Vcom[5]. Accordingly, the pixels coupled to the common line Vcom[5] are distributed basically parallel to the direction of the gate line GL[5].

The common voltage supply unit 13 is electrically coupled to each of the plurality of common lines (Vcom[1], Vcom[2], . . . Vcom[5]) for providing independent voltages to the common lines.

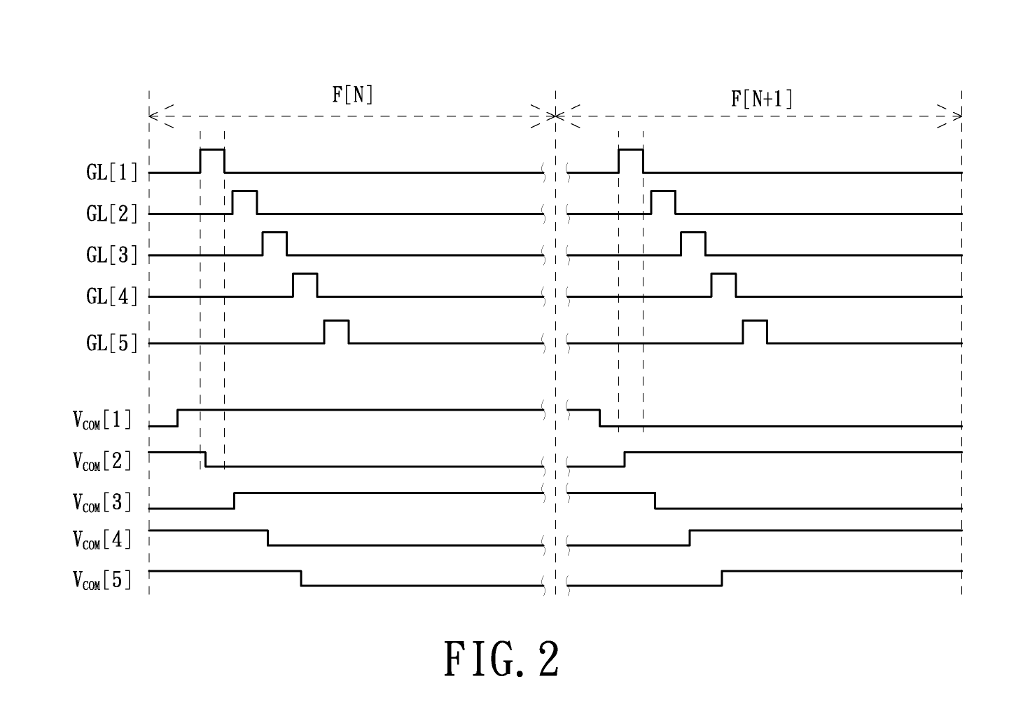

Please further refer to FIG. 2, which is a signal waveform diagram illustrating level changes of signals transmitted through the gate lines and common lines of the LCD device shown in FIG. 1 in two consecutive frames.

As shown in FIG. 2, during the displaying of the frame F[N], the voltage level of the common line Vcom[1] is changed by the common voltage supply unit 13 from a first voltage level to a second voltage level before the voltage level of the gate line GL[1] changes.

For example, after the voltage level of the common line Vcom[1] changes from a low voltage level to a high voltage level, the voltage level of the gate line GL[1] changes from low to high. Afterwards, the voltage level of the gate line GL[1] changes from high to low to have data written into the pixels 11 electrically coupled to the common line Vcom[1]. Meanwhile, the voltage level of the common line Vcom[1] is kept at the high voltage level, i.e. the second voltage level.

Subsequently, during the displaying of next frame F[N+1], the voltage level of the common line Vcom [1] is changed by the common voltage supply unit 13 from the second voltage level to the first voltage level. The voltage level change of the common line Vcom[1] occurs prior to the change of the voltage level at the gate line GL[1]. As can be seen from FIG. 2, the gate line GL[1] changes from the high voltage level to the low one soon after the voltage level at the common line Vcom[1] changes from low to high. Afterwards, after the voltage level of the gate line GL[1] changes from high to low, data are written into the pixels 11 electrically coupled to the common line Vcom[1]. Meanwhile, the voltage level of the common line Vcom[1] is kept at the low level, i.e. the first voltage level.

Since the timing relationships between gate lines GL[2], GL[3] . . . GL[5] and common lines Vcom[2], Vcom[3] . . . Vcom[5] are similar to the one between the gate line GL[1] and common line Vcom[1], operational details are not redundantly described.

It is understood from FIG. 2 that the two adjacent common lines associated with the same gate line behave differently. Take the common lines Vcom[1] and Vcom[2] for instance. The first common line Vcom[1] changes its voltage level before the corresponding gate line GL[1] is toggled. On the other hand, the second common line Vcom[2] does not change its voltage level until the gate line GL[1] is toggled, and is prohibited from changing its voltage level in advance.

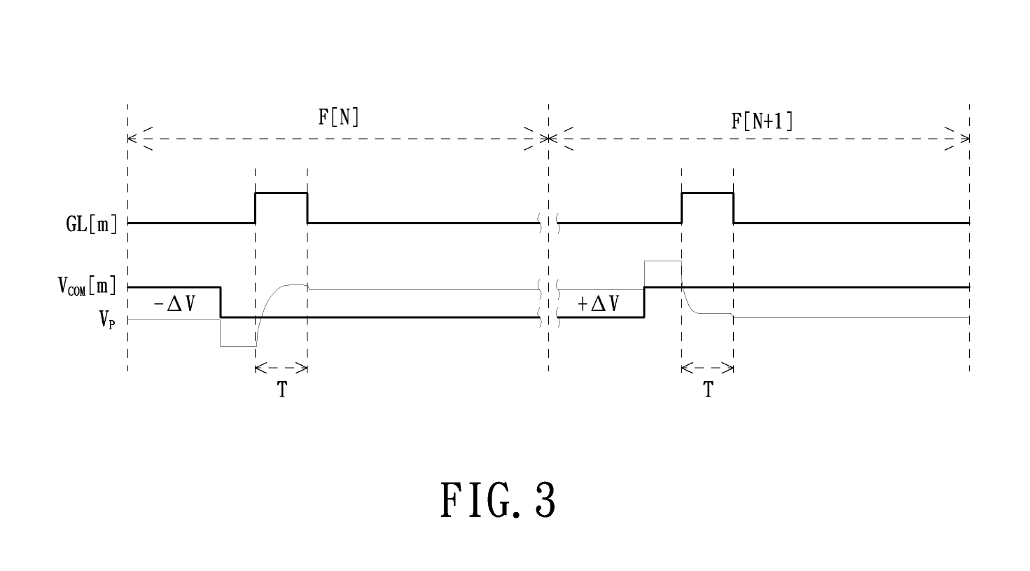

Please further refer to FIG. 3, which is a signal waveform diagram level changes of signals transmitted through a specified common line and a corresponding gate line as well as voltage changes of the pixel electrode of a pixel coupled to the common line.

In the exemplary FIG. 1, the label “m” is shown to be a value between 1 to 5. A pixel 11 coupled to the common line Vcom [m], assuming being written thereinto data with a positive polarity, i.e. positive gray level voltage in the frame F[N], will be written thereinto data with a negative polarity, i.e. negative gray level voltage in the frame F[N+1].

As shown in FIG. 3, during the displaying of the frame F[N], the voltage level of the common line Vcom[m] changes from high to low, e.g. from +5 volts to 0 volts, before the gate line GL[m] changes in an opposite manner. The voltage difference of the common line Vcom[m] is represented as (−ΔV).

As the pixel 11 is in an “off” state at this time point, a terminal of the storage capacitor Cst included in the pixel 11 and coupled to a terminal of the pixel transistor Tp (corresponding to the pixel electrode) is floating. Hence the voltage level of the pixel electrode of the pixel 11 correspondingly decreases with a level ΔV due to the coupling effects with the capacitor Cst.

After the voltage level of the gate line GL[m] changes from low to high, the pixel electrode in the pixel 11 is charged to a target voltage level in a data write-in period T in order to display the pixel at the target gray level. For example, the target voltage level is a specific voltage level between 0 volts to 5 volts.

Subsequently, during the displaying of the frame F[N+1], the voltage level of the common line Vcom[m] changes from low to high, e.g. from 0 volts to +5 volts, before the voltage level of the gate electrode GL[m] changes likewise. The voltage difference of the common line Vcom[m] is represented as (+ΔV).

As the pixel 11 is in an “off” state at this time point, the terminal of the storage capacitor Cst included in the pixel 11 and coupled to the terminal of the pixel transistor Tp (corresponding to the pixel electrode) is floating. Hence the voltage level of the pixel electrode of the pixel 11 correspondingly increases with a level ΔV due to the coupling effects with the capacitor Cst.

After the voltage level of the gate line GL[m] changes from low to high, the pixel electrode in the pixel 11 is charged to another target voltage level in a data write-in period T in order to display the pixel at the target gray level. For example, the target voltage level may be another specific voltage level between 0 volts to 5 volts.

In other words, in a case that the polarity of the data to be provided to the pixel 11 is positive, the voltage level of the common line Vcom[m] changes to the low voltage level. On the other hand, in a case that the polarity of the data to be provided to the pixel 11 is negative, the voltage level of the common line Vcom[m] changes to the high voltage level.

According to the disclosure illustrated hereinbefore, a small change of the voltage level provided to the pixel 11 is enough to achieve the required gray level voltage and thus the target gray level display of the pixel. It is advantageous in decreasing power consumption of, for example, the driver IC.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving a liquid crystal display device free of upper substrate, comprising:
providing a plurality of independent common lines;
electrically coupling a specified one of the plurality of common lines to a specified group of pixels;
changing a voltage level of the specified common line from a first level to a second level before data are written into the specified group of pixels; and
keeping the voltage level of the specified common line at the second level after the data are written into the specified group of pixels.

2. The method according to claim 1, wherein the second level is a low level if a polarity of the data to be written into the specified group of pixels is positive, and the second level is a high level if a polarity of the data to be written into the specified group of pixels is negative.

3. A liquid crystal display device free of upper substrate, comprising:
a plurality of pixels;
a plurality of data lines for providing data to the pixels therethrough, a specified one of the plurality of data lines being electrically coupled to a specified group of pixels selected from the plurality of pixels, wherein two adjacent pixels in the specified group are disposed oppositely relative to the specified data line;
a plurality of gate lines for controlling timing of transferring data from the plurality of data lines to corresponding ones of the plurality of pixels;
a plurality of common lines, electrically coupled to corresponding groups of pixels selected from the plurality of pixels, respectively; and
a common voltage supply unit, electrically coupled to the plurality of common lines for independently providing a voltage level to each of the plurality of common lines, wherein the voltage level is changed from a first level to a second level before data are written into the group of pixels electrically coupled to the corresponding common line, and kept at the second level after data are written into the group of pixels electrically coupled to the corresponding common line.

4. The liquid crystal display device according to claim 3, wherein a specified one of the plurality of common lines is electrically coupled to another specified group of pixels selected from the plurality of pixels, wherein two adjacent pixels in the another specified group of pixels are electrically coupled to adjacent two of the plurality of gate lines, respectively.

5. The liquid crystal display device according to claim 4, wherein the plurality of pixels forming a pixel array, the plurality of data lines are distributed in columns within the pixel array, and the plurality of gate lines are distributed in rows within the pixel array; and wherein the specified common line is distributed substantially in rows while in a zigzag manner so that the another specified group of pixels include a first row of pixels coupled to one of the two adjacent gate lines and a second row of pixels coupled to the other of the two adjacent gate lines.

6. The liquid crystal display device according to claim 4, wherein the second level is a low level if a polarity of the data to be written into the specified group of pixels is positive, and the second level is a high level if a polarity of the data to be written into the specified group of pixels is negative.

7. The liquid crystal display device according to claim 3, wherein the second level is a low level if a polarity of the data to be written into the specified group of pixels is positive, and the second level is a high level if a polarity of the data to be written into the specified group of pixels is negative.
